(19) United States
(12) Patent Application Publication
(10) Pub. No.: US 2011/0313808 A1
(43) Pub. Date: Dec. 22, 2011

(54) Built Environment Management System and Method

(75) Inventors: James Thomas Kavanagh, Wells, ME (US); Alex James Telford, Portland, ME (US)

(73) Assignee: 4Tell Solutions, Portland, ME (US)

(21) Appl. No.: 12/818,785

(22) Filed: Jun. 18, 2010

(51) Int. Cl. G06Q 10/00

(52) U.S. Cl. 705/7.23

(57) ABSTRACT

A computer-implemented method is provided for producing a capital plan for the built environment of an organization. Data relating to components of the built environment such as buildings, assets, infrastructure, systems, components, energy infrastructure, and security infrastructure can be collected. Plan items for recommended projects can be produced through analysis, modeling, and scheduling routines based on the data. Organizational objectives can be identified and the plan items can be evaluated through configurable algorithms to determine which plan items best meet the organizational objectives. The execution of plan items can be managed through completion and the resulting ongoing performance can be monitored.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to the field of management and sustainability of the built environment management, and more specifically to strategy planning and capital planning with respect to physical assets, facilities, and structures to control aspects such as lifecycle replacement, energy consumption, environmental impacts, functional use, security and stakeholder reporting in organizations.

### BACKGROUND

In today's business environment, organizations are held to higher standards of accountability, compliance, and efficiency than at any time in the past. All indicators suggest that this trend will continue into the future. As a result, organizations—throughout both public and private sectors—are facing new, significant challenges in managing the built environment. Generally, the built environment can include buildings, facilities, infrastructure, roadways, and virtually any significant machine, component, or structure in the organization. To be competitive, today's businesses need to operate efficiently as well as make intelligent capital spending decisions with respect to the built environment.

For example, as fears of global warming and environmental change continue to spread throughout the world, new national and international regulations are being put in place to regulate business activity and promote sustainability. Meanwhile, a concerned public is putting social pressure on companies to operate in an efficient, sustainable, and environmentally friendly manner. Accordingly, businesses are forced to revise and optimize virtually every aspect of the way they run operations and make capital spending decisions. In addition, fears of disaster and terrorism, stemming in part from the events of September 11, are stimulating regulation in the area of security, prompting organizations to take security measures into account as well in operating and developing the built environment. Moreover, through advances in information and computing technology, increasing availability of resources, and the general leveling of the business landscape nationally and internationally, barriers to competition are fading and forcing companies to operate at unprecedented levels of efficiency or lose out to the competition.

Existing built environment management systems offer point solutions for various aspects of the built environment. Namely, existing systems isolate a particular aspect of the built environment, such as energy consumption, carbon emissions, facility and asset maintenance, work order management, and many more while ignoring other aspects of the organization's operations. Hence, such systems provide a series of discrete data points regarding various aspects of an organization's built environment while providing limited guidance as to the “big picture” and the interrelation between the various aspects. Accordingly, such systems provide limited guidance as to the strategic capital plans and related actions that the organization should carry out in order to best meet business objectives in a most efficient and effective manner given the organization's resources.

Furthermore, existing systems often operate as a “snapshot”, giving the organization a picture of a particular aspect of its operations at a given time in the form of a report or an assessment. However, such reports become quickly dated because they cannot “adapt” to the organization as the organization grows and changes. In addition, such reports fail to inform or “teach” the organization about the impacts that certain improvements or changes are having on the organization.

What is needed is a system and method for built environment management that integrates into an organization's business and takes into account the various aspects of the organization's built environment to produce holistic intelligence, capital spending plans, and strategic plans encompassing all of the various needs of the organization both near and long term. As will be demonstrated, the invention performs this task in an elegant manner.

### BRIEF DESCRIPTION OF THE DRAWINGS

FIG. 1 is a block diagram illustrating an example of a built environment and a capital plan system capable of implementing the systems and methods discussed herein.

FIG. 2 is a block diagram illustrating various components of a capital plan system in accordance with various embodiments.

FIG. 3 is a flow diagram illustrating a procedure for producing capital plan recommendations in the capital plan system, in accordance with various embodiments.

FIG. 4 is a block diagram illustration of the capital planning system in accordance with various embodiments.

FIG. 5 is a flow diagram illustrating a procedure for producing capital plan recommendations in the analysis and recommendations module, in accordance with various embodiments.

FIG. 6 illustrates an example determination of a plan item-scoring algorithm and the application of the algorithm to plan items, in accordance with various embodiments.

FIG. 7 is a block diagram illustrating an example computing device.

### DETAILED DESCRIPTION

In the following description, numerous specific details are set forth in order to provide a thorough understanding of the present invention. However, it will be apparent to one skilled in the art that the present invention can be practiced without these specific details. In other instances, well known circuits, components, systems, software, algorithms, and processes have not been shown in detail or have been illustrated in schematic or block diagram form in order not to obscure the present invention in unnecessary detail. Additionally, for the most part, details concerning enterprises and enterprise systems, components of the built environment, networking and computing systems, and the like have been omitted inasmuch as such details are not considered necessary to obtain a complete understanding of the present invention and are considered to be within the understanding of persons of ordinary skill in the relevant art. It is further noted that, where feasible, all functions described herein may be performed in either hardware, software, firmware, digital components, or analog components or a combination thereof, unless indicated otherwise. Certain terms are used throughout the following description and Claims to refer to particular system components. As one skilled in the art will appreciate, components may be referred to by different names. This document does not intend to distinguish between components that differ in name, but not function. In the following discussion and in the Claims, the terms “including” and “comprising” are used in an open-ended fashion, and thus should be interpreted to mean “including, but not limited to . . . ”

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with applications and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

The systems and methods described herein provide an intelligent and efficient way to manage the built environment of an organization. In various embodiments, the described systems and methods can comprise gathering information about the built environment, determining organizational needs and objectives, and recommending projects to improve the built environment based on the gathered information and the organization's needs and objectives.

As used herein, the term “built environment” can refer to any buildings, facilities, roadways, vehicles, machinery, structures, security systems, energy systems, infrastructure, or other physical components and systems in an organization. As used herein, the term “infrastructure,” where applicable, refers to fundamental systems that are implemented to add functions to structures, buildings, and facilities; for example, sewer systems, power delivery systems, water delivery systems, communication network systems, and so on can be part of the infrastructure.

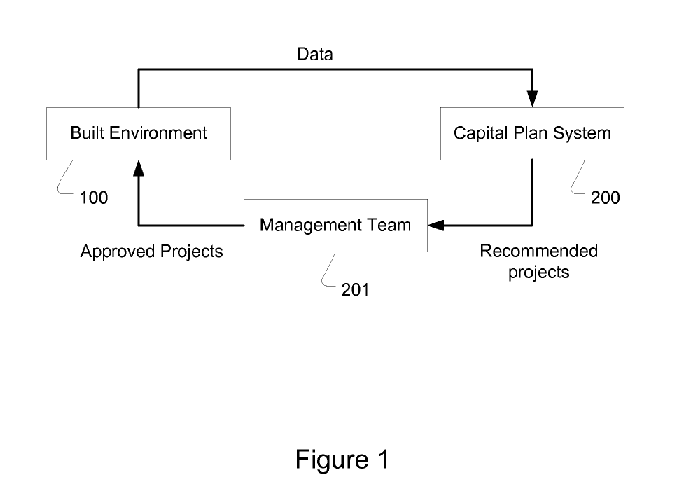

FIG. 1 is a block diagram illustrating an example of a built environment and a capital plan system capable of implementing the systems and methods discussed herein. Data from a built environment 100 can be conveyed to a capital plan system 200. Generally, the data can include any information regarding the built environment that may be used in managing the built environment. For example, the data can include information about various buildings in the organization such as age, location, leases, space, occupancy, and so on. Similarly, data can be conveyed regarding other assets such as roadways, facilities, machines, etc. The data can include information about components of systems, such as HVAC systems, windows, doors, paint, the roof, machinery within a building, and other components. Further, data regarding systems such as energy infrastructure can be conveyed, for example, consumption data for electricity, gas, or other fuels in the form of utility bills, meter readings, and so on can be conveyed. Data regarding security infrastructure, such as the types and conditions of windows, doors, locks, passageway layouts, security cameras, alarms, locations of parking structures, distances to roadways, whether the organization is in rural or urban locations, and so on can be similarly conveyed.

The data can be conveyed using any methods of data transfer. For example, the data can be conveyed to the capital plan system 200 from another device such as a computer or a metering module through a network, such as the Internet, or through a series of networks. The data can also be directly entered into the capital plan system 200 by another system or by an individual.

The data can be generated manually, for example through an assessment performed by an engineer on facility conditions or through a gap analysis of existing data to understand any missing elements, and then conveyed to the capital plan system 200. Further, the data can be conveyed from other systems or software within the organization such as enterprise resource planning (ERP); lease, space, and occupancy software, enterprise asset management (EAM), integrated workplace management systems (IWMS), computerized maintenance management system (CMMS), building automation systems (BAS), energy systems, and environment control systems.

In the capital plan system 200, the data can be analyzed to determine a recommended project or set of projects. As will be described in further detail below, the capital plan system 200 can be configured to produce and prioritize lifecycle capital plans and project recommendations according to organizational objectives. The recommended projects can be conveyed to a management team 201, which management team 201 can include the decision-making individuals in the organization, for approval. The management team 201 can approve one or more projects. A prioritization model can be developed and deployed across the organization to support the decision-making process and counteract the subjective nature of the management effort. The approved projects can be implemented in the built environment and new data reflecting the implemented projects can be conveyed to the capital plan system 200.

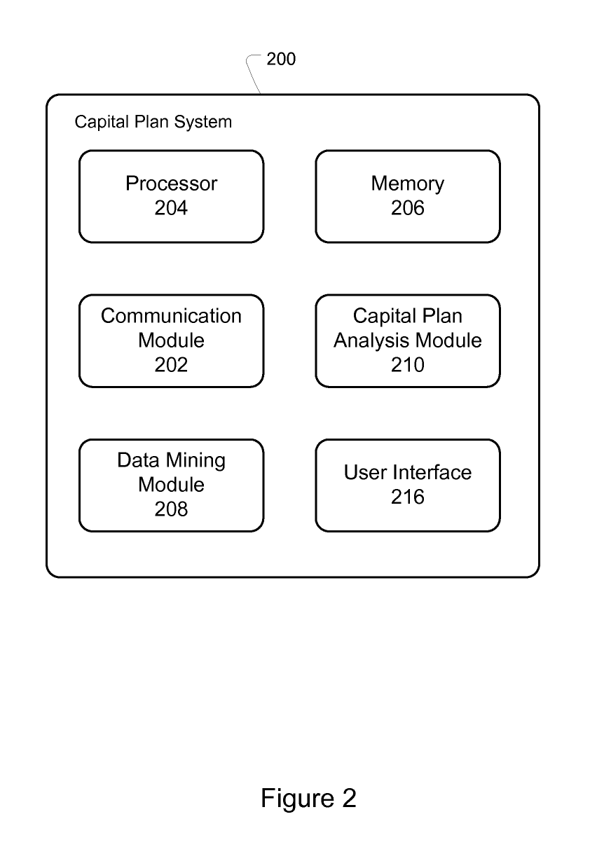

FIG. 2 is a block diagram illustrating various components of a capital plan system in accordance with various embodiments. The capital plan system 200 can include a communication module 202, a processor 204, a memory 206, a data mining module 208, a user interface 216, and a capital plan analysis module 210. The communication module 202 can allow the capital plan system 200 to communicate with other devices and systems, such as other user devices, enterprise systems, and databases. Processor 204 can execute various instructions to implement the functionality provided by the capital plan system 200. Memory 206 can store these instructions as well as other data used by processor 204 and other modules contained in the capital plan system 200.

The data mining module 208 can search for data through knowledge bases. The capital plan analysis module 210 can analyze available data, such as information regarding the built environment, organizational objectives, project costs, and other user inputs to formulate recommended projects.

The user interface 216 allows administrators and users to interact with the various components of the capital plan system 200. In certain embodiments, user interface 216 also allows a user to interact with one or more components of the capital plan system 200 to perform tasks such as configure, modify, and/or customize the capital plan system 200.

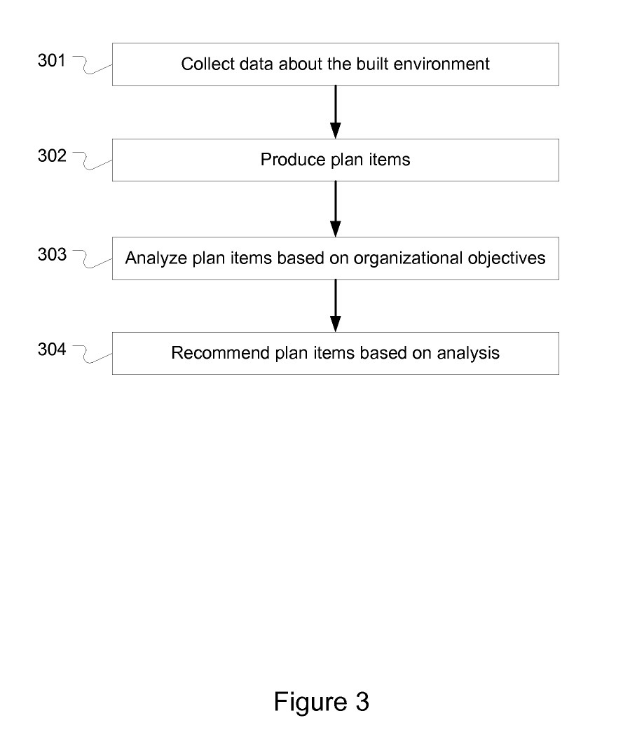

FIG. 3 is a flow diagram illustrating a procedure for producing capital plan recommendations in the capital plan system, in accordance with various embodiments. Data about the built environment can be collected throughout the organization 301. Data can be collected with respect to any systems and structures in the built environment of the organization. Plan items can be produced 302 based on the collected data. A plan item can be any project in the built environment that can be carried out at some point in time. The data can be analyzed using a variety of scheduling routines to produce plan items, which plan items can be proposals to carry out certain actions or projects in the built environment. Scheduling routines can comprise modeling, prioritization, and scheduling techniques that analyze data and produce plan items to improve the built environment. For instance, a plan item can be a project or recommendation to replace a ventilation unit, repair a roofing system, remove asbestos piping, or install closed circuit cameras. Hence, a scheduling routine can input data such as the age of a ventilation unit, its efficiency, cost of operation, and so on into an algorithm or a model, which algorithm or model can produce a plan item to replace the ventilation unit at some point in time.

In various embodiments, plan items can be produced automatically, such as by systems, software, and/or algorithms that analyze the data about the built environment and produce plan items. For example, the age, efficiency, and condition of a water heater in a building may be analyzed and a plan item to replace the water heater may be produced if an algorithm determines that it is cost efficient to replace the water heater at a particular point in time. Similarly, data about the types of windows, the local climate, and/or efficiency of heating and cooling of the building may be analyzed and a plan item may be produced to replace the windows with double-pane glass. Further, data about building security, such as the types of doors, alarm systems, and locks in the building can be analyzed and a plan item can be produced to replace the doors, alarm systems, and locks with more secure components.

Generally, modeling techniques can be used to produce plan items for any aspects of the built environment, such as asset condition, energy, carbon footprint, security, and any others. Such models can be simple, such as a model that recommends that any window older than 20 years is replaced and produces corresponding plan items. Other models can be complicated, such as a model that simulates the entire organization to produce plan items regarding areas such as energy, security, carbon footprint, and others. For example, to produce an energy-related plan item, a building may be modeled over the period of one year in a simulation taking into account elements such as weather, occupancy, hours of use, predicted costs of utilities, and other factors. Plan items may be determined from the simulations by measuring which elements of the building, if improved, will best reduce costs for the organization. When plan items are implemented, the models used in the simulations that produce plan items may be updated based on the actual improvement produced by implementing the plan item and the predicted improvement.

Plan items can originate in various dimensions of the built environment. For example, plan items can be categorized into the categories asset infrastructure, energy infrastructure, and security infrastructure. Plan items in the asset infrastructure category can correspond to improving the condition of any assets in the built environment. Examples of assets can be buildings, facilities, machines, vehicles, infrastructure, and so on. Examples of plan items in the asset infrastructure can be plan items to replace a water heater, repair a roof, improve plumbing, repaint a building, repave a roadway, and so on. Plan items in the energy infrastructure can correspond to improving the energy consumption and/or emissions in the built environment. Examples of plan items in the energy infrastructure can be plan items to replace an air conditioning unit with a more efficient one, install insulation or double pane windows, install energy-saving lights, install a more efficient furnace, and so on. Plan items in the security infrastructure can correspond to improving safety in the built environment from terrorist attacks, crimes, and disasters. Examples of plan items in the security infrastructure can be plan items to reinforce structures, install surveillance systems, produce emergency exits, and so on.

Currently, separate, isolated systems and services are available in the industry for producing plan items or otherwise recommending projects in various sectors of the built environment. For example, one system or service may be available for determining when components of a building's heating, cooling, and ventilation system should be replaced; another system or service may be available for determining what energy saving projects should be carried out; another system or service may be available for determining when a building should be repainted, when the roof should be replaced, and when the roads should be repaved; while yet another system or service may be available to recommend what measures to undertake to improve security. However, each of these systems provides segregated items of data that cannot be analyzed in one system, or in one algorithm, without converting the data into a uniform format. Hence, such a segregated collection of data points does not provide any information with respect to which plan items should be implemented to most efficiently apply a capital budget. Furthermore, such segregated collections of data points do not provide information on how the various plan items inter-relate, and hence which plan items or combination of plan items best meet corporate objectives.

Hence, in various embodiments, plan items in the various dimensions of the built environment can be produced under a uniform format, such that any set of plan items can be analyzed together. For example, plan items corresponding to the asset infrastructure, energy infrastructure, and security infrastructure can all be analyzed together, such as by applying certain algorithms to the plan items, to determine which plan items, or combination of plan items, will best meet overall corporate objectives. Accordingly, by having the capability to analyze, on one platform, plan items across different dimensions of the organization in view of the organizational objectives, more informed and comprehensive capital investment strategies can be developed and effective spending decisions can be made. For example, an organization may need $10 million in a given fiscal year to sustain current levels of built environment performance. However, only $4 million may be available for the capital budget. Knowledge can be created through strategic analysis of plan items across different dimensions of the organization to identify how the plan items align and support the organization's business needs, providing for the most effective use of the available capital funds and ensuring that the organization can justify where, how, why, and when the funds are deployed.

In various embodiments, plan items can be auto-generated based on raw data and based on industry best-practices and/or predetermined standards, such as the ASTM E2018-08 Standard Guide for Property Condition Assessments for asset conditions; the Facility Energy Decision System (FEDS) for energy related aspects; the ASTM E917-05 Standard Practice for Measuring Life-Cycle Costs of Buildings and Building Systems; the Federal Emergency Management Agency (FEMA) 426/429 protocols; and/or the Department of Defense (DoD) Anti-Terrorism standards for security compliance.

Alternatively, plan items may be produced manually; that is, the management team in the organization may produce a plan item and input it into the capital planning system for analysis. For example, the management team may be considering adding a solar panel installation on a rooftop. The team can create a plan item for the installation and input the plan item as well as all related data into the capital plan system 200 manually instead of having one of the automatic systems produce it. In various embodiments, the management team can modify a plan item that was created automatically. Further, the management team can remove a plan item from the system.

Various scheduling routines, software, algorithms, and systems for producing plan items and any corresponding models are available and known in the art and will not be described here in detail as those details are not considered necessary for a complete understanding of the invention.

Furthermore, each plan item can have a variety of classification data attached to it, to aid in analysis, which classification data can be any type of data that can be used in categorizing plan items. For example, each plan item can have a predicted cost of implementing the plan item attached to it. Each plan item can have location data, such as in what city and/or in what building the plan item will be implemented. Further, each plan item can have type data attached to it with respect to what aspect of the organization or what system the plan item will most likely effect; for example, plan item types can be energy plan type items, security plan type items, asset infrastructure plan type items, carbon footprint type items, and so on. Attaching such data allows a user to, for example, configure the system to produce plan items that meet a certain budgetary constraint, or that affect a certain building or location, or that pertain to a certain aspect of the organization, such as security, for example.

Further, each plan item can have data attached to it citing the predicted or estimated effects that implementing the plan item will have on the organization. For example, the data about predicted effects can be an estimate that implementing the plan item will have a strong impact on energy consumption and a moderate impact on security in the organization. In various embodiments, the system can be configured to select which particular aspects of the organization, such as energy, security, emission, life safety, etc. are important to the organization. Accordingly, the data attached to each plan item regarding the predicted effects that implementing the plan item will have on the organization can cite the predicted effect that the plan item will have on each of those aspects that are important to the organization. The predicted effects can be derived from models and algorithms, inputted manually, or produced from a pre-determined index compiled for such a purpose. As will be described in further detail below, such predicted effects can be termed “plain item factors”. As will be further described below, each plan item factor for each plan item can be assigned a relative rank that indicates the predicted or estimated relative degree of impact that implementing the plan item will have on the corresponding aspect of the organization.

When plan items are implemented, the predicted data, such as the cost of the plan item and the predicted results that the plan item has on various aspects of the organization, can be updated based on the actual costs incurred in implementing the plan item and the actual effect that the plan item had on the various aspects of the organization. For example, if it was predicted that replacing a furnace would cost $20,000 and produce $2,000 per year of savings, but instead replacing the furnace cost $18,000 and produced $1,500 per year of savings, then future predictions of the cost of replacing the furnace and its effects can be modified to reflect the observed data.

In various embodiments, generated plan items can be analyzed in the capital plan system 200 based on the organization's objectives 303 to estimate which plan items best meet the objectives. Plan items can be recommended based on the analysis 304. In an embodiment, several plan items can be recommended with various degrees of emphasis, for example, ten plan items can be ranked from most recommended to least recommended. In various embodiments, a set of plan items that most efficiently meets organizational objectives can be recommended.

For example, the capital plan system 200 can be configurable according to a set of organizational objectives and the capital plan 200 system can weigh plan items and recommend plan items according to those objectives. For instance, if life safety and carbon emissions are the most important objectives for the organization, then the capital plan system 200 can be configured to recommend plan items that the capital plan system 200 estimates will best meet the life safety and carbon emission objectives in the organization. Namely, data regarding the predicted effects that each plan item will have on various aspects of the organization can be analyzed to determine which plan items will best meet the organization objectives. For instance, in the above example, all plan items can be analyzed and weighed to determine which plan items are predicted to have the greatest impact on life safety and carbon emissions; the plan items or sets of plan items that most effectively meet those objectives can be recommended.

Various algorithms and methods can be used to perform the analysis 303. In various embodiments, the algorithms can be configurable to allow users of the capital planning system 200 to define organizational goals and modify those goals as the goals change or to test various scenarios. In various embodiments, users can configure the algorithms directly by changing the relationships and parameters in the algorithms. In other embodiments, an interactive user interface can be implemented in the system where the user is able to input preferences through surveys, questionnaires, selectable options, and so on and the system can configure the algorithms according to the user inputs. For example, the user may be presented with a survey that allows the user to select organizational objectives from a list of optional organizational objectives and allows the user to assign relative ranks in terms of relative importance of the objectives to the organization; for example, the user may be allowed to assign a rank on a scale of one to five to each of a set of five different organizational objectives. Further, the user can be allowed to select which buildings, locations, or aspects of the built environment the organization would like to improve. Further, the user can be allowed to select or input financial constraints, such as a maximum budget for projects, or a required minimal ROI (return on investment) for projects. Accordingly, based on the user inputs, the system can alter the algorithms and/or select some plan items and not others, or place more weight on certain types or classifications of plan items in the analysis to reflect user preferences.

In various embodiments, organizational objectives can include any aspect of the organization such as energy usage, security, health safety, and compliance. The objectives can also include certain industry benchmark parameters, such as energy efficiency or carbon footprint benchmarks. For example, benchmarks can be obtained from the U.S. Department of Energy Portfolio Manager and Energy Star. In such a case, the capital planning system 200 can be configured to recommend plan items that help the organization meet the benchmark objectives. Similarly, the capital plan system 200 can be configured to recommend plan items according to certain classifications. For example, if the organization is most concerned with specific segments of the organization, such as a particular building, then the capital plan system 200 can be configured to recommend plan items in that particular segment, such as the particular building; or, the capital plan system 200 can be configured to place more recommending priority on the plan items in that particular segment. Other examples of classifications can be by geographic location, by type of building, or by the type of functions performed in a building. Furthermore, the capital planning system 200 can recommend plan items according to various constraints, such as budgetary or financial constraints. For example, the capital planning system 200 can be configured to recommend plan items that produce the largest (ROI) return on investment or can be implemented under a certain limited budget. Such analysis can be performed based on the classification data attached to the plan items and/or based on data with respect to the estimated or predicted effect that implementing a plan item will have on the organization.

Hence, a user can configure the system to recommend plan items according to various combinations of organizational requirements and objectives. For example, a user may desire to identify plan items that affect a particular building, are under a determined budget, and serve the objectives of reducing the carbon footprint. In this case, the system can be configured to select plan items that affect only the particular building. Out of those items, the system can be configured to select plan items under the determined budget or combinations of plan items under the determined budget. Out of those plan items, the system can be configured to recommend plan items based on the predicted effect that the plan items will have on the objective of reducing the carbon footprint, with the plan item or set of plan items having the greatest effect receiving the highest recommendation.

Various organizations can have numerous objectives of varying types. This specification does not intend to limit the invention to any particular type of organizational objective. As will be understood by a person of reasonable skill in the art, various types of organizational objectives can be implemented in the described capital planning system 200 without straying from the scope of the invention.

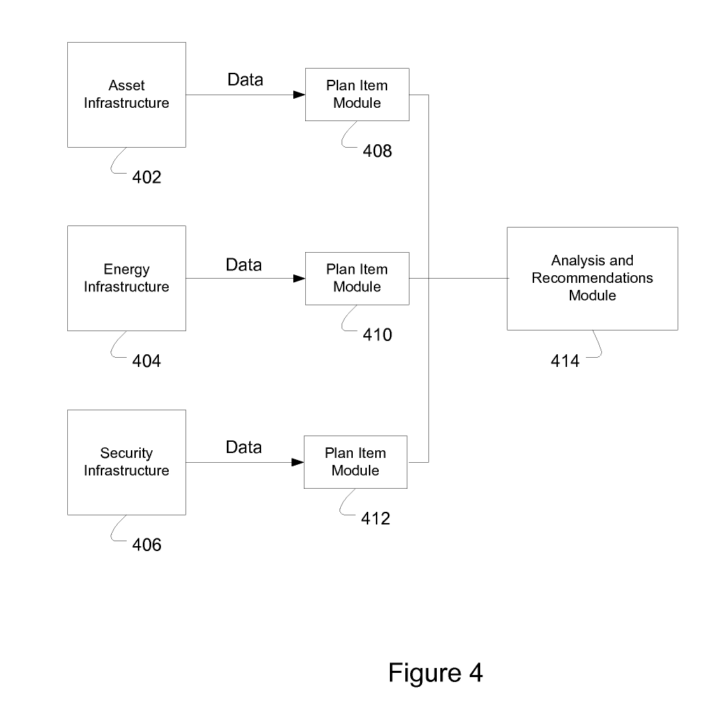

FIG. 4 is a block diagram illustration of the capital planning system 200 in accordance with various embodiments. As described above, an asset infrastructure 402 can comprise physical assets in the built environment such as buildings, roadways, and facilities. Data about the conditions of components in the asset infrastructure can be conveyed to a plan item module 408. The data can comprise information about assets such as the age, type, and functional condition of the assets, as described above. In the plan item module 408, models and scheduling routines can be applied to the data, as described, to produce plan items.

An energy infrastructure 404 can comprise various energy consuming systems, such as heating, air conditioning, machinery, and facilities. Data about the energy infrastructure can be conveyed to a plan item module 410. The data can comprise information such as utility bills, meter readings, equipment age, equipment efficiency, and so on, as described above. In the plan item module 410, models and scheduling routines can be applied to the data, as described, to produce plan items.

A security infrastructure 406 can comprise various safety and terrorism prevention systems, such as reinforced glass, reinforced walls, alarm systems, barriers, layouts of roadways and parking lots, escape exits, and so on. Data about the security infrastructure can be conveyed to a plan item module 412. The data can comprise information such as types of windows, types of structural reinforcements, distances to roadways, and the type of location (e.g., rural or urban), and so on, as described above. In the plan item module 412, models and scheduling routines can be applied to the data, as described, to produce plan items.

The plan items from the plan item modules 408, 410, and 412 can be conveyed to an analysis and recommendations module 414. In the analysis and recommendations module 414, the plan items can be analyzed and weighed based on organizational objectives and requirements and the plan items can be recommended according to how well they are predicted to meet the organizational objectives.

Various methods can be used to analyze plan items and produce recommendations in the analysis and recommendations module 414. Organizational objectives can be identified and corresponding “consideration factors” can be determined. For example, if lowering energy consumption is an organizational objective, then energy efficiency can be a consideration factor. Algorithms can be applied to analyze each plan item and estimate the effect that the plan item has on the identified consideration factors based on the predicted effects of each plan item. An algorithm can be modeled to select the plan items that best meet corporate objectives with respect to the consideration factors. In various embodiments, the plan items can be recommended based on the estimated effects that each plan item has on the identified consideration factors. For example, an organization can identify security, life safety, and energy as the three most important consideration factors. In the analysis and recommendations module 414, an algorithm can be applied to each plan item to determine the plan item's effect on the consideration factors. For example, the algorithm can give each plan item a score based on the plan item's effect on the consideration factors. In various embodiments, the algorithm can take into account which consideration factors are more important to the organization and give additional weight to plan items that have a greater impact on those consideration factors. For example, if life safety is more important to the organization than other factors, then plan items that have a positive effect on life safety can receive additional weight in the algorithm.

Similarly, if meeting a benchmark is important to an organization, such a benchmark can be a consideration factor. In that case, the algorithm can place additional weight on plan items that have a positive effect on the organization achieving the benchmark goal. For example, if a benchmark is related to energy efficiency, then the algorithm can give greater weight to plan items that have a positive effect on the organization's energy efficiency.

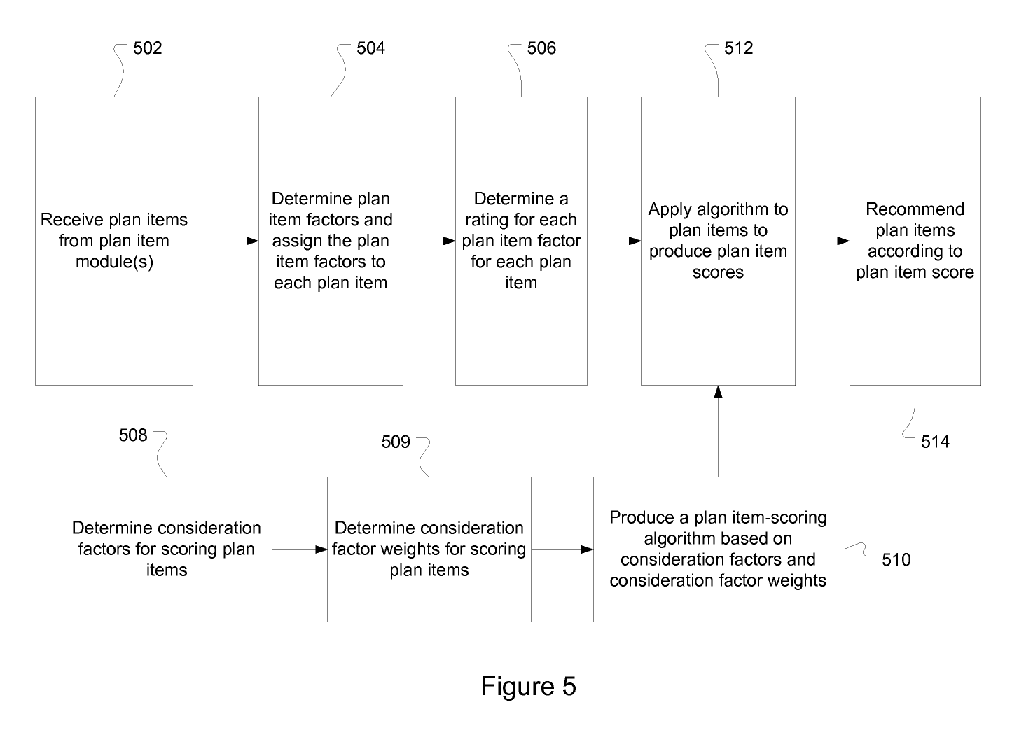

FIG. 5 is a flow diagram illustrating a procedure for producing capital plan recommendations in the analysis and recommendations module 414, in accordance with various embodiments. Plan items can be received from plan item modules 502, such as the plan item modules 408, 410, and 412 in FIG. 4. Plan item factors can be determined and assigned to each plan item 504. Plan item factors can be any factors by which the organization may wish to evaluate the predicted effects that plan items may have on the organization. Each plan item factor can correspond to the effect that implementing the plan item can have on the corresponding aspect of the organization. Some examples of plan item factors can be: health safety, which is a non-life-threatening impact on human safety in an organization; life safety, which is a life-threatening impact on human safety in an organization; carbon footprint, which refers to impacts on carbon emissions; energy, which refers to impacts on energy requirements; sister-component damage, which refers to damage to other components within the organization that can occur as a result of component failure such a roof leaking through and causing damage to equipment; compliance, which can refer to impacts on avoiding liability as a result of failing to comply with legal mandates in various disciplines; ADA compliance, which can refer to impacts on compliance with the ADA (Americans with Disabilities Act); environmental impact, which can refer to impacts on the environment such as hazardous waste and water pollution. Another plan item factor can be political influence, which can refer to the level of priority of a plan item based on political factors that may be associated with the plan item, such as the seniority of the creator of the plan item. For example, plan items that are created by or associated with high-level executives in a company can have a more favorable rating for the political influence plan item factor than other plan items. Another example of a plan item factor is lifecycle, which can refer to the expected life of an improvement made by implementing a plan item. Yet another example of a plan item factor can be functional suitability, which can refer to the difficulties involved in implementing a plan item in the current environment. For example, a plan item that can be implemented without modification to the existing environment, such as a furnace unit that swaps directly with an old unit, can have a favorable functional suitability factor rating. Whereas, a plan item that cannot be implemented without significant modification to the existing environment, such as a ventilation unit for which there is no space and no pre-existing ducting in the environment, can have an un-favorable functional suitability factor rating. A set of plan item factors can be chosen according to the objectives of the organization and assigned to each plan item. For example, each plan item can be assigned the plan item factors of energy, health safety, and security; if those aspects of the built environment are the important aspects for the organization. In such a case, every produced plan item will have corresponding data indicating the effect that implementing the plan item will have on the plan item factors of energy, health safety, and security.

After plan item factors are assigned, a rating can be determined for each plan item factor of each plan item 506. The ratings can be on a pre-determined scale and can correspond to the predicted relative effect that the corresponding plan item can have on the respective aspect of the organization associated with the particular plan item factor. Such ratings can be estimates of the relative degree of the impact that the plan item will have on the aspect of the organization corresponding to the plan item factor. For example, the ratings can be on a scale of one to five, where a rating of five for a plan item factor indicates that the plan item will have a strong impact on the aspect of the organization corresponding to the plan item factor and a rating of one for the plan item factor indicates that the plan item will have a weak impact on the aspect of the organization corresponding to the plan item factor. For example, the plan item for replacing a water heater may have a rating of four for the plan item factor “energy”; two for the plan item factor “health safety”; and one for the plan item factor “security”, indicating that executing the heater plan item will have a strong impact on energy, a small impact on health safety, and a negligible impact on security. In various embodiments, modeling techniques, for example techniques such as the ones used to produce plan items, can be used to determine the plan item factor ratings. Also, plan item factor ratings can be retrieved from pre-determined indices, such as asset class and functional indices listing various predicted effects that various plan items may have on aspects of an organization. Alternatively, plan item factor ratings can be inputted manually by users of the system.

Further, the particular ranking scales and ranking systems can vary according to the particular needs, preferences, and objectives of an organization. Similarly, the recommendations algorithm and the particular methods of weighing plan item factors can vary between organizations and can be configurable within an organization to produce recommendations for various objectives and to allow scenario planning. Similarly, plan items can be selected according to classification; for example, plan items can be selected based on classification data attached the plan items. For example, plan items that correspond to a particular building, or a particular location, can be analyzed to the exclusion of the rest of the organization; alternatively, plan items in a desired building or location may be given more weight than the rest of the organization. In addition, budgets can be taken into account. Namely, the algorithm can recommend plan items under a certain budget, which plan items meet certain requirements; or, the algorithm can recommend sets of plan items under a certain budget, which sets meet certain requirements. As will be appreciated by a person of reasonable skill in the art, various methods can be used to produce and rank plan items according to an organization's objectives and will not be covered here in detail as such details are not considered necessary for a complete understanding of the invention.

Hence, consideration factors for scoring plan items can be determined based on organizational objectives 508. Consideration factors corresponding to the aspects of the organization that the users of the system desire to improve or analyze can be selected so that plan items are scored according to the selected consideration factors to support the decision making process. For example, if a user desires to improve energy consumption and health safety in the organization, then plan items can be scored based on the impact of the plan items on energy and health safety. Accordingly, the consideration factors “energy” and “health safety” can be selected. Each consideration factor can correspond to a plan item factor. Namely, the consideration factor “energy” can correspond to the plan item factor “energy.” Additionally, the user can identify other constraints, such as budgetary constraints or location, which can limit which plan items or sets of plan items are analyzed.

After consideration factors are selected, weights for scoring plan items can be determined for the considerations factors 509. For example, if one consideration factor is more important than other consideration factors, then a higher weight can be assigned to that consideration factor than the other consideration factors. In the previous example, for instance, if “health safety” is more important than “energy” to an organization, then a weight of “3” can be assigned to the “health safety” consideration factor and a weight of “2” can be assigned to the “energy” consideration factor. A matrix effect can be driven by the consideration factor because a certain building may have a higher value to an organization than another building and an equally rated “energy” consideration may have an overall lower or higher rating pertaining to one building than to another building as a result of the relevant importance of the buildings to the business objectives of the organization.

In various embodiments, a strategic planning consulting process can be used to define organizational goals and objectives, which process can in turn define and/or rank the consideration factors for the prioritization model(s) that are then developed. Such processes can be presented to the user through a user interface of the system such as a computer display; for example, through interactive questionnaires, options, or surveys. Namely, as described above, the users of the system can be given a series of questions, options, and/or surveys to identify the organization's objectives and corresponding consideration factors as well as the relative importance of the consideration factors. For example, the user can be asked to select a set of organizational objectives and assign ranks on a scale of one to five, in terms of relative importance, to the selected organizational objectives. The set of organizational objectives can be used to determine the consideration factors. Further, the ranks that the user assigns to the organizational objectives can be used to determine the corresponding consideration factor weights of each respective consideration factor. As will be apparent to one skilled in the art, various methods and techniques, such as interactive surveys, questionnaires, and so on can be used to elicit organizational objectives, rankings, and preferences; further, various methods and techniques can be used to configure the system and any applicable algorithms based on the user input and will not be covered here in detail as such detail is not considered necessary for a complete understanding of the invention.

Based on the consideration factors and the corresponding consideration factor weights, an algorithm can be developed for scoring plan items 510. For example, the algorithm can assign a score for each plan item by summing the products of consideration factor weights and the corresponding plan item factors. Hence, in the above example, if a weight of “3” is assigned to “health safety” and a weight of “2” is assigned to “energy”, then a plan item's score would be the sum of the plan item's factor rating for health safety multiplied by “3” and the plan item's factor rating for “energy” multiplied by “2”.

As described, the algorithm can be applied to various plan items to produce a score for each plan item 512. The plan items can be recommended according to the produced plan item scores 514. For example, the plan items or sets of plan items with the highest scores can receive the strongest recommendation and the plan items with lower scores can receive correspondingly lower recommendations. As will be understood by a person of reasonable skill in the art, the described algorithm is provided by way of illustration and other algorithms employing different functions and different factors and quantities of factors can be implemented without straying from the scope of this disclosure.

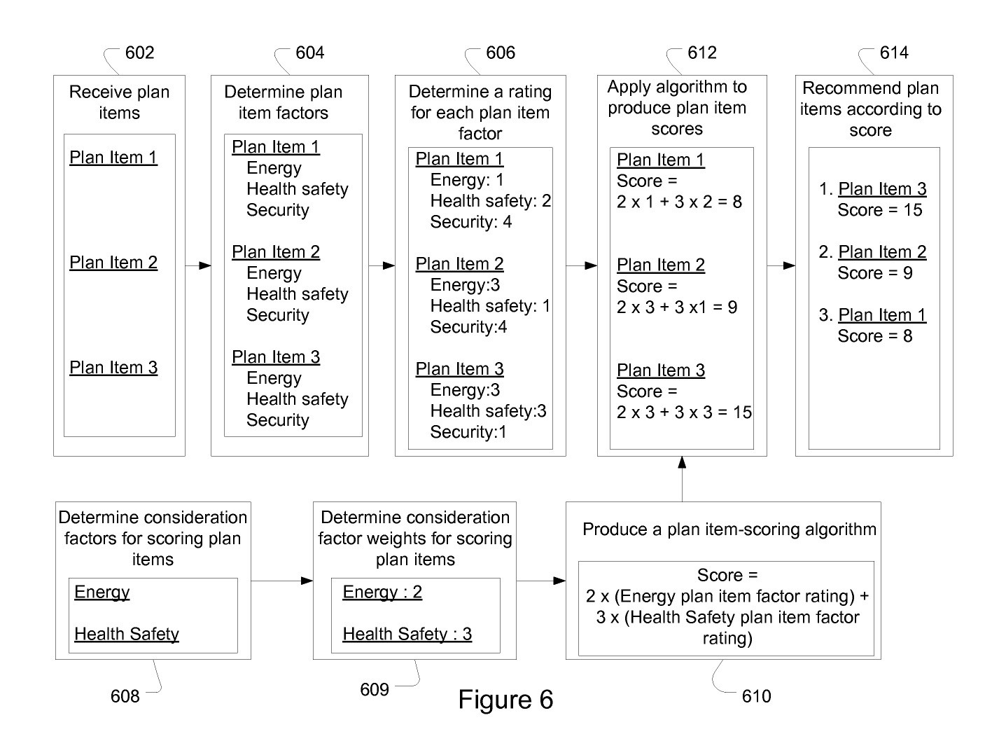

FIG. 6 illustrates an example determination of a plan item-scoring algorithm and the application of the algorithm to plan items, in accordance with various embodiments. Plan items can be received from plan item modules 602, such as the plan item modules 408, 410, and 412 in FIG. 4. Plan item factors can be determined and assigned to each plan item 604. As illustrated, each plan item can be assigned the plan item factors of “energy”, “health safety”, and “security”. After plan item factors are assigned, a rating can be determined for each plan item factor of each plan item 606. The ratings can be on a scale of one to five, where a rating of five for a plan item factor indicates that the plan item will have a strong impact on the aspect of the organization corresponding to the plan item factor and a rating of one for the plan item factor indicates that the plan item will have a weak impact on the aspect of the organization corresponding to the plan item factor. As illustrated, Plan Item 1 can have a rating of 1 for the plan item factor “energy”; two for the plan item factor “health safety”; and four for the plan item factor “security”; indicating that executing Plan Item 1 will have a negligible impact on energy, a small impact on health safety, and a strong impact on security. As illustrated, Plan Item 2 and Plan Item 3 can have unique ratings for each plan item factor as well. As described above, the plan item factor ratings can be produced automatically, such as by algorithms, obtained from indices, or inputted manually.

Further, as described, the particular ranking scales and ranking systems can vary according to the particular needs, preferences, and objectives of an organization. Similarly, the recommendations algorithm and the particular methods of weighing plan item factors can vary between organizations and can be configurable within an organization to produce recommendations for various objectives and to allow scenario planning. Similarly, plan items can be selected according to classification. For example, plan items that correspond to a particular building, or a particular location, can be analyzed to the exclusion of the rest of the organization; alternatively, plan items in a desired building or location may be given more weight than the rest of the organization. In addition, budgets can be taken into account. Namely, the algorithm can recommend plan items under a certain budget, which plan items meet certain requirements; or, the algorithm can recommend sets of plan items under a certain budget, which sets meet certain requirements. As will be appreciated by a person of reasonable skill in the art, various methods can be used to produce and rank plan items according to an organization's objectives and will not be covered here in detail as such details are not considered necessary for a complete understanding of the invention.

Consideration factors for scoring plan items can be determined based on organizational objectives 608, as described above. As illustrated, the consideration factors “energy” and “health safety” can be selected. The consideration factor “energy” can correspond to the plan item factor “energy”, and the consideration factor “health safety” can correspond to the plan item factor “health safety”.

After consideration factors are selected, weights for scoring plan items can be determined for the considerations factors 609. As illustrated, a weight of “3” can be assigned to the “health safety” consideration factor and a weight of “2” can be assigned to the “energy” consideration factor, indicating that “health safety” is more important than “energy” to the organization at least for the purposes of this analysis.

Based on the consideration factors and the corresponding consideration factor weights, a plan item-scoring algorithm can be developed for scoring plan items 610. The algorithm can assign a score for each plan item by summing the products of consideration factor weights and the corresponding plan item factors. As illustrated, the algorithm in the example of FIG. 6 can be:

Score=2×(Energy plan item factor rating)+3×(Health Safety plan item factor rating),

where “2” is the weight corresponding to the “energy” consideration factor and “3” is the weight corresponding to the “health safety” consideration factor. Hence, to develop a score for a plan item, the plan item's energy plan item factor rating is multiplied by “2”, the plan item's health safety plan item factor rating is multiplied by “3”, and the two products are added. As described, the algorithm can be applied to each plan item to produce a score for each plan item 612. The plan items can be recommended according to the produced plan item scores 614, with the highest scoring plan item, Plan Item 3, being recommended first and the plan items with lower scores receiving correspondingly lower recommendations. As will be understood by a person of reasonable skill in the art, the described algorithm is provided by way of illustration and other algorithms employing different functions and different factors and quantities of factors can be implemented without straying from the scope of this disclosure.

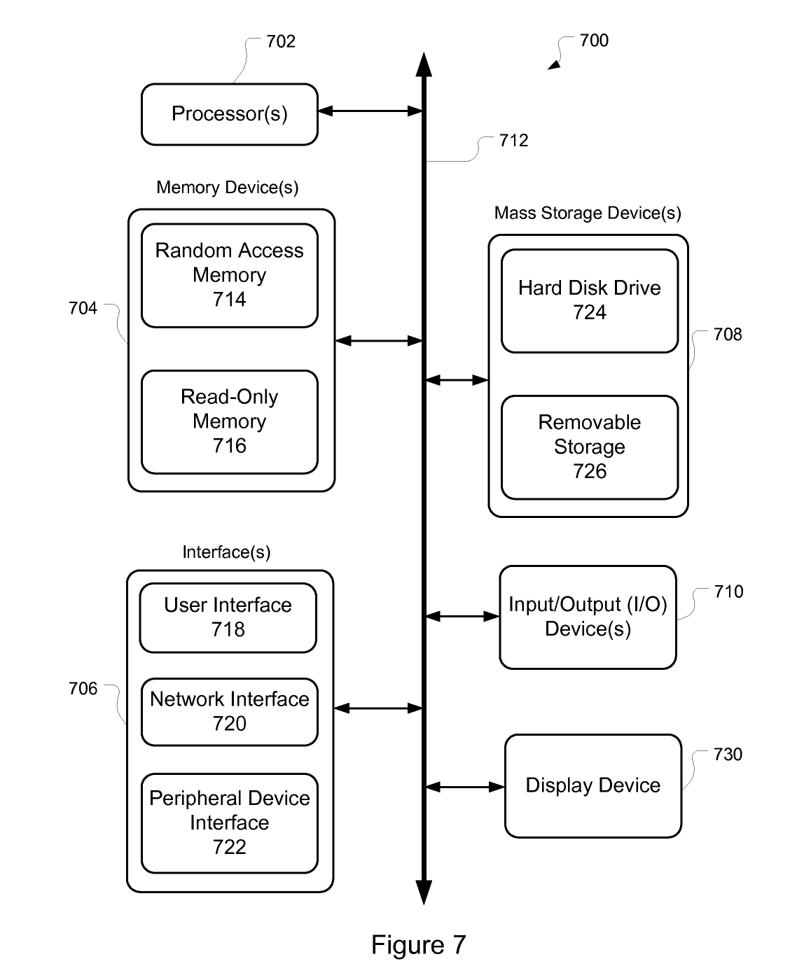

FIG. 7 is a block diagram illustrating an example computing device 700. Computing device 700 may be used to perform various procedures, such as those discussed herein. Computing device 700 can function as a capital plan system or a portion of a capital plan system, or any other computing entity. Computing device 700 can be any of a wide variety of computing devices, such as a desktop computer, a notebook computer, a server computer, a handheld computer, and the like.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM)) 714 and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid state memory (e.g., Flash memory), and so forth. One type of mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, lenses, CCDs or other image capture devices, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments. Example interface(s) 706 include any number of different network interfaces 720, such as interfaces to local area networks (LANs), wide area networks (WANs), wireless networks, and the Internet. Other interfaces include user interface 718 and peripheral device interface 722.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Microsoft tools, Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the system and method described herein facilitate managing the built environment of an organization and producing capital plans. Although the components and modules illustrated herein are shown and described in a particular arrangement, the arrangement of components and modules may be altered to perform analysis and produce capital plans in a different manner. In other embodiments, one or more additional components or modules may be added to the described systems, and one or more components or modules may be removed from the described systems. Alternate embodiments may combine two or more of the described components or modules into a single component or module.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

1. A computer implemented method comprising:
collecting data associated with the built environment of an organization;
producing plan items based on the collected data, wherein the plan items are projects that can be implemented in the built environment;
performing an analysis of the plan items; and
recommending one or more plan items based on the analysis of the plan items.

2. The method of claim 1, wherein the data associated with the built environment comprises data associated with at least one of: asset infrastructure, energy infrastructure, and security infrastructure.

3. The method of claim 1, wherein the data associated with the built environment comprises data associated with any two of: asset infrastructure, energy infrastructure, and security infrastructure.

4. The method of claim 1, wherein the data associated with the built environment comprises data associated with asset infrastructure, energy infrastructure, and security infrastructure.

5. The method of claim 1, wherein the plan items are generated through scheduling routines.

6. The method of claim 1, wherein the analysis of the plan items comprises weighing plan items based on plan item classification data.

7. The method of claim 6, wherein the classification data comprises at least one of: plan item location data, plan item cost data, and plan item type data.

8. The method of claim 1, wherein the analysis of the plan items comprises weighing the plan items based on predicted effects that implementing each plan item is estimated to have on the organization.

9. The method of claim 1, further comprising determining at least one plan item factor, wherein a plan item factor corresponds to an aspect of the organization that is affected by implementing plan items.

10. The method of claim 9, wherein the at least one plan item factor is at least one of: energy, compliance, ADA compliance, sister component damage, carbon footprint, life safety, functional suitability, environmental impact, lifecycle, political influence, and health safety.

11. The method of claim 9, further comprising:
assigning a rating for the at least one plan item factor for each plan item, which rating estimates the relative degree of the impact that the plan item is estimated to have on the aspect of the organization corresponding to the at least one plan item factor, wherein the analysis of the plan items comprises determining a score for each plan item based on the plan item factor ratings of the plan item, and where the one or more plan items are recommended based on the determined scores of the plan items.

12. The method of claim 11, further comprising:
selecting at least one consideration factor that correspond(s) to the at least one plan item factor; and
selecting a corresponding consideration factor weight for each consideration factor, wherein each consideration factor weight is based on the relative importance of the consideration factor to the organization;
wherein the scores of the plan items are determined based on the plan item factor ratings of each plan item and the corresponding consideration factor weights.

13. The method of claim 11, wherein the score of a plan item is based on a value calculated by multiplying each plan item factor rating of the plan item by the corresponding consideration factor weight and adding the products of plan item factor ratings and consideration factor weights.

14. A system comprising:
a processor; and
a storage memory encoded with a set of instructions that when executed by said processor, cause the processor to execute the steps of:
performing an analysis of plan items, which plan items are projects that can be implemented in the built environment, and which plan items are produced based on data associated with the built environment of an organization; and
recommending one or more plan items based on the analysis of the plan items.

15. The system of claim 14, wherein the data associated with the built environment comprises data associated with any two of: asset infrastructure, energy infrastructure, and security infrastructure.

16. The system of claim 14, wherein the analysis of the plan items comprises weighing the plan items based on predicted effects that implementing each plan item is estimated to have on the organization.

17. A machine-readable storage medium carrying one or more sequences of instructions, which instructions, when executed by one or more processors, cause the one or more processors to carry out the steps of:
performing an analysis of plan items, which plan items are projects that can be implemented in the built environment, and which plan items are produced based on data associated with the built environment of an organization; and
recommending one or more plan items based on the analysis of the plan items.

18. The machine-readable storage medium of claim 17, wherein the data associated with the built environment comprises data associated with any two of: asset infrastructure, energy infrastructure, and security infrastructure.

19. The machine-readable storage medium of claim 17, wherein the data associated with the built environment comprises data associated with asset infrastructure, energy infrastructure, and security infrastructure.

20. The machine-readable storage medium of claim 17, wherein the analysis of the plan items comprises weighing the plan items based on predicted effects that implementing each plan item is estimated to have on the organization.
